(19) United States
(12) Patent Application Publication
(10) Pub. No.: US 2026/0208674 A1
(43) Pub. Date: Jul. 23, 2026

(54) RETRACTABLE AND EXTENDABLE CAMERA MIRROR DEVICE

(71) Applicant: SL Mirrortech Corporation, Siheung-si (KR)

(72) Inventors: Yonghwan KIM, Gyeongsan-si (KR); Yonghei KIM, Gyeongsan-si (KR); Wonbin KIM, Gyeongsan-si (KR); Yeongkook CHO, Gyeongsan-si (KR)

(21) Appl. No.: 19/367,506

(22) Filed: Oct. 23, 2025

(30) Foreign Application Priority Data
Oct. 31, 2024 (KR) 10-2024-0151856
Oct. 31, 2024 (KR) 10-2024-0151859

(51) Int. Cl. B60R 1/25; B60R 1/10; B60R 1/26; B60R 1/27

(52) U.S. Cl. CPC B60R 1/25; B60R 1/26; B60R 1/27; B60R 1/10; B60R 2300/102; B60R 2300/8046

(57) ABSTRACT

A retractable and extendable camera mirror device includes a camera assembly movable in a first direction into and out of a vehicle body through an opening of a vehicle body panel; a first link having a first end pivotably connected to a first coupling portion of the camera assembly to pivot about a first hinge shaft; a second link having a first end pivotably connected to a second coupling portion of the camera assembly to pivot about a second hinge shaft; a connection link having both ends pivotably connected to a second end of the first and second links via first and second connection shafts, respectively, the connection link being movable along a second direction intersecting the first direction; and a driver that transmits a driving force to the first link via a driving link that pivots about a driving shaft for a movement of the camera assembly.

### CROSS-REFERENCE TO RELATED APPLICATIONS

This application claims priority from Korean Patent Application No. 10-2024-0151856 filed on Oct. 31, 2024 and Korean Patent Application No. 10-2024-0151859 filed on Oct. 31, 2024. The aforementioned applications are incorporated herein by reference in their entireties.

### BACKGROUND

### 1. Technical Field

The present disclosure relates to a camera mirror device, and more particularly, to a retractable and extendable camera mirror device which allows at least one camera to extend from or retract into a vehicle body.

### 2. Description of Related Art

In general, an inside mirror is installed in an interior of a vehicle to allow a driver to perceive a rear situation around the vehicle, an outside mirror is installed on each of both opposing front doors of the vehicle to allow the driver to perceive a side and rear situation around the vehicle. The driver may perceive another vehicle or pedestrian in situations such as backing, passing, lane change, etc. based on a field of view secured by the inside mirror and the outside mirror.

Recently, a camera mirror using a camera instead of the outside mirror is being used to reduce air resistance when a vehicle is operating and reduce the possibility of damages due to an external impact. Images around the vehicle obtained by the camera mirror is displayed through a display device provided inside the vehicle, so that the driver may more easily identify other vehicles, pedestrians, and the like.

Since such a camera mirror is exposed outside the vehicle body not only when the vehicle is being operated but also when the vehicle is not operated, there is a possibility of damage thereto due to an external impact or contamination due to inflow of foreign substances, and thus, there is a need for an approach for preventing damages and contamination of the camera mirror when the vehicle is not operating.

### SUMMARY

The present disclosure is designed to solve the above problems, and a technical purpose to be achieved by the present disclosure is to provide a retractable and extendable camera mirror device that allows a camera to move into and out of a vehicle body.

In addition, another technical purpose to be achieved by the present disclosure is to provide a retractable and extendable camera mirror device which prevents a sagging issue due to a weight thereof and unnecessary movement when the camera moves into and out of a vehicle body.

In addition, still another technical purpose to be achieved by the present disclosure is to provide a retractable and extendable camera mirror device in which components are used without modification even when a distance by which a camera extends from the vehicle body is changed.

In addition, still yet another technical purpose to be achieved by the present disclosure is to provide a retractable and extendable camera mirror device which allows an operator (e.g., a human driver) to directly and manually place the camera out of the vehicle body to enable a vehicle driving even in an emergency situation.

The technical purposes of the present disclosure are not limited to the above-mentioned ones, and other technical purposes not mentioned may be clearly understood by a person skilled in the art of the present disclosure from the following description.

In order to achieve the purpose, a retractable and extendable camera mirror device in accordance with one embodiment of the present disclosure may include a camera assembly that is movable in a first direction into and out of a vehicle body through an opening provided in a vehicle body panel; a first link having a first end pivotably connected to a first coupling portion of the camera assembly to allow the first link to pivot about a first hinge shaft; a second link having a first end pivotably connected to a second coupling portion of the camera assembly to allow the second link to pivot about a second hinge shaft; a connection link having both ends thereof pivotably connected to a second end of the first link and a second end of the second link via a first connection shaft and a second connection shaft, respectively, the connection link being configured to be movable along a second direction that intersects the first direction; and a driver that transmits a driving force to the first link via a driving link that pivots about a driving shaft for a movement of the camera assembly. The camera assembly may include a housing unit including a camera housing and a housing cover coupled to each other to form a camera receiving space for accommodating at least one camera therein. A spacing between the first hinge shaft and the second hinge shaft may be equal to a spacing between the first connection shaft and the second connection shaft.

In some embodiments, the housing unit may be constructed such that a joint line formed by assembling the camera housing and the housing cover with each other is formed on a surface that is invisible from a view point above the camera mirror device such that a surface of the housing unit appears to the viewer as having a single continuous surface. The housing cover may be coupled to a lower surface of the camera housing, and an upper surface and a side surface of the camera housing may constitute the single continuous surface.

An outer surface of the housing unit that faces outward from the vehicle body may include a body surface, which, when the camera assembly is in a retracted state into the vehicle body, is disposed flush with the vehicle body panel to constitute a coplanar body line of the vehicle; and a inclined surface that extends from a lower end of the body surface in an inclined manner toward an inside of the vehicle body.

A lens of the at least one camera may protrude outward beyond the inclined surface through an exposure hole formed in the inclined surface.

The retractable and extendable camera mirror device may further include a shield configured to seal or screen a spacing between the opening of the vehicle body panel and a lower end of the inclined surface when the camera assembly is retracted into the vehicle body. The shield may include an outer cover configured to surround at least a portion of the camera assembly so that the spacing between the opening of the vehicle body panel and the lower end of the inclined surface is sealed or screened with the outer cover when the camera assembly is retracted into the vehicle body.

In some embodiments, the first coupling portion may include a plurality of first side walls, to allow the first hinge shaft to pass through the first end of the first link, and each of both ends of the first hinge shaft to be inserted into each of the plurality of first side walls. The second coupling portion may include a plurality of second side walls, to allow the second hinge shaft to pass through the first end of the second link, and each of both ends of the second hinge shaft to be inserted into each of the plurality of second side walls.

The first connection shaft and the second connection shaft may be arranged along the second direction, and a first end of each of the first connection shaft and the second connection shaft may be movably inserted into a guide groove, which is formed in a base and extends along the second direction, to allow the connection link to be movable along the second direction.

The retractable and extendable camera mirror device may further include a guide cover including a receiving groove that extends along an arrangement direction of the first connection shaft and the second connection shaft, where the receiving groove faces the guide groove. A second end of each of the first connection shaft and the second connection shaft may be movably inserted into the receiving groove to allow the second end of each of the first connection shaft and the second connection shaft to move along the receiving groove as the first end of each of the first connection shaft and the second connection shaft moves along the guide groove.

The guide cover may be integrally formed with the base.

The base may include at least one guide rail formed thereon to extend along a moving direction of the camera assembly.

A first end of the driving link may be connected to the driving shaft that rotates about a driving axis, and a second end thereof may be pivotably connected to a center of the first link via a central shaft. An angle between the central shaft and the first connection shaft with respect to the driving axis when the camera assembly is in a retracted state into the vehicle body may be different from an angle between the first hinge shaft and the central shaft with respect to the driving axis when the camera assembly is in an extended state from the vehicle body.

An extension distance by which the camera assembly extends from the vehicle body may be different from a displacement distance of the connection link.

In some embodiments, the retractable and extendable camera mirror device may further include a manual manipulator that causes a portion of the camera assembly to extend out of the vehicle body through the opening to allow an operator to manually extend the camera assembly out of the vehicle body. The manual manipulator may include a push shaft that is movable along the first direction; a cable to which an external force for moving the camera assembly is input; and at least one transmission link that transmits the external force input to the cable to the push shaft to cause the push shaft to move along the first direction.

An end of the push shaft may be in contact with one of the camera assembly, the first link, the second link, or the connection link to allow a portion of the camera assembly to extend out of the vehicle body through the opening by the external force input to the cable.

The at least one transmission link may include a first transmission link having a first end mounted on a mounting bracket to pivot about a first shaft; and a second transmission link having a first end pivotably connected to a second end of the first transmission link via a second shaft, and a second end of the second transmission link may be pivotably connected to the push shaft via a third shaft.

The cable may be connected to at least one of the first transmission link or the second transmission link, and in response to an external force that pulls the cable being input thereto, the second shaft may move along a guide hole formed in the mounting bracket and having a constant radius around a center of the first shaft.

In response to the external force of pulling the cable being input thereto, the second shaft may move in a direction from a first end toward a second end of the guide hole to allow an angle between the first shaft and the third shaft with respect to the second shaft to increase.

The manual manipulator may further include an elastic member that biases the second shaft from the second end toward the first end along the guide hole.

In response to the external force of pulling the cable being input thereto, the elastic member may be compressed and the second shaft may be moved toward the second end of the guide hole to allow the push shaft to move along the first direction, and the angle between the first shaft and the third shaft with respect to the second shaft may increase. In response to the external force pulling the cable being removed therefrom, the second shaft may move toward the first end of the guide hole by a restoring force of the elastic member to allow the push shaft to return to a base position, and thus the angle between the first shaft and the third shaft with respect to the second shaft may decrease.

Other specific features of the present disclosure are included in the detailed description and drawings.

According to the retractable and extendable camera mirror device of the present disclosure as described above, there are one or more of the following effects.

The camera assembly may extend out of the vehicle body so as to be exposed when the vehicle is operated. The camera assembly may retract into an interior space defined in the vehicle body when the vehicle is not operated. Thus, there is an effect of preventing damages due to an external impact or contamination due to the inflow of foreign substances when the vehicle is not operated.

In addition, even when the camera assembly cannot be extended with the driving force of an actuator, the camera assembly can still be extended by the human driver so as to be exposed out of the vehicle body, thereby enabling the vehicle to be driven even in an emergency situation, and thus enabling a rapid response thereto.

In addition, the parting line of the housing unit of the camera assembly is not visible to a viewer out of the vehicle in a state in which the camera assembly extends out of the vehicle body so as to be exposed, there is an effect of preventing deterioration of the outer appearance design.

In addition, the outer surface facing outwardly of the housing unit of the camera assembly includes the body surface constituting the body line of the vehicle and the inclined surface that extends from the lower end of the body surface in the inclined manner toward the inside of the vehicle body. The image of the surroundings around the vehicle can be obtained through an exposure hole formed in the inclined surface. Thus, even when two or more cameras are installed, the camera assembly may be prevented from protruding outwardly of the vehicle body in a state in which the camera assembly has retracted into the vehicle body.

The effects of the present disclosure are not limited to the effects mentioned above, and other effects not mentioned will be clearly understood by those skilled in the art from the description of the claims.

### BRIEF DESCRIPTION OF DRAWINGS

The above and other aspects and features of the present disclosure will become more apparent by illustrating in detail embodiments thereof with reference to the attached drawings, in which:

FIGS. 1 and 2 are schematic diagrams showing a retractable and extendable camera mirror device installed in a vehicle according to an embodiment of the present disclosure;

FIGS. 3 to 6 are perspective views illustrating a retractable and extendable camera mirror device in a retracted state according to an embodiment of the present disclosure;

FIGS. 7 and 8 are exploded perspective views showing a retractable and extendable camera mirror device in a retracted state according to an embodiment of the present disclosure;

FIG. 9 is a plan view showing a retractable and extendable camera mirror device in a retracted state according to an embodiment of the present disclosure;

FIG. 10 is a cross-sectional view illustrating a first coupling portion of a movable portion coupled to a first link according to an embodiment of the present disclosure;

FIG. 11 is a cross-sectional view illustrating a second coupling portion of a movable portion coupled to a second link according to an embodiment of the present disclosure;

FIG. 12 is a perspective view illustrating a through hole of a movable portion through which a guide rail passes according to an embodiment of the present disclosure;

FIG. 13 is a cross-sectional view illustrating a guide cover coupled to a base according to an embodiment of the present disclosure;

FIG. 14 is a perspective view illustrating a retractable and extendable camera mirror device in an extended state according to an embodiment of the present disclosure;

FIG. 15 is a plan view illustrating a retractable and extendable camera mirror device in an extended state according to an embodiment of the present disclosure;

FIG. 16 is a schematic diagram illustrating positions of a first link and a second link when a camera assembly according to an embodiment of the present disclosure is extended.

FIG. 17 is a side view illustrating a manual manipulator in a normal state according to an embodiment of the present disclosure;

FIG. 18 is a side view illustrating a camera assembly movable under manual operation according to an embodiment of the present disclosure;

FIG. 19 is a plan view illustrating a camera assembly movable under manual operation according to an embodiment of the present disclosure;

FIG. 20 is a schematic diagram showing a shield according to an embodiment of the present disclosure;

FIGS. 21 and 22 are schematic diagrams showing a shield according to another embodiment of the present disclosure; and

FIG. 23 is a schematic diagram showing a shield according to still another embodiment of the present disclosure.

### DETAILED DESCRIPTIONS

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some embodiments, well-known steps, structures and techniques will not be described in detail to avoid obscuring the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the disclosure are described herein with reference to plan and cross-section illustrations that are schematic illustrations of exemplary embodiments of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. In the drawings, respective components may be enlarged or reduced in size for convenience of explanation.

Hereinafter, the present disclosure will be described with reference to drawings for illustrating a retractable and extendable camera mirror device according to embodiments of the present disclosure.

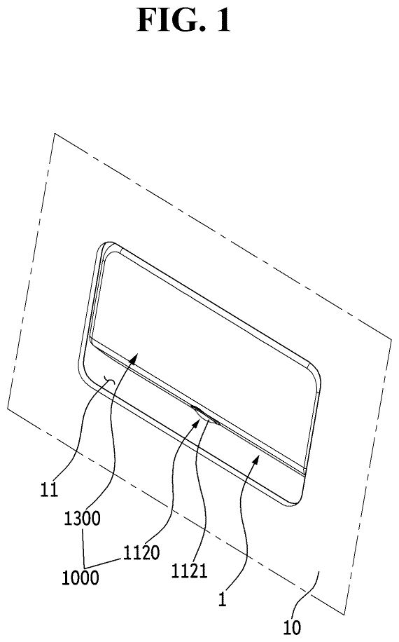

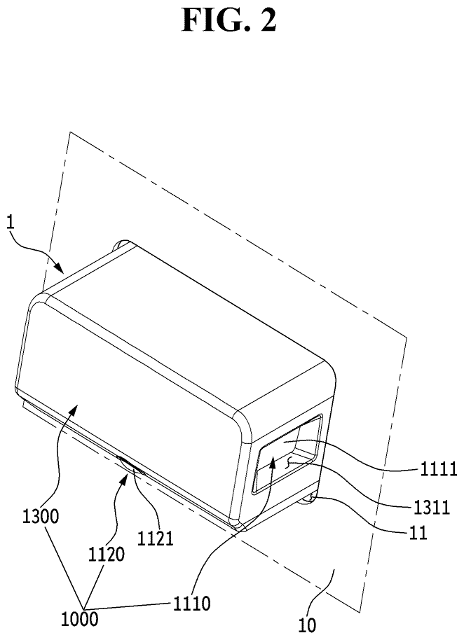

FIGS. 1 and 2 are schematic diagrams showing a retractable and extendable camera mirror device installed in a vehicle according to an embodiment of the present disclosure.

Referring to FIGS. 1 and 2, in a retractable and extendable camera mirror device 1 according to some embodiments of the present disclosure, at least a portion of a camera assembly 1000 may be extended to protrude out of a vehicle body through an opening 11 formed in a vehicle body panel 10 when the vehicle is operated, thereby obtaining images in at least one direction around the vehicle body. When the vehicle is not operated, the camera assembly 1000 may be retracted so that the camera assembly 1000 is disposed in an interior space of the vehicle body and the camera assembly 1000 may be disposed flush with the vehicle panel 10, thereby forming the vehicle body contour and preventing damages of the camera assembly 1000 due to an external impact or contamination due to introduction of foreign substances.

In this regard, FIG. 1 illustrates a state in which the camera assembly 1000 is retracted inside the interior space defined in the vehicle body. FIG. 2 illustrates a state in which at least a portion of the camera assembly 1000 is extended to be exposed out of the vehicle body.

In an embodiment of the present disclosure, a case in which the retractable and extendable camera mirror device 1 is installed on a front door or adjacent to the front door of the vehicle and serves as an outside mirror for securing a side and rear view around the vehicle or functions as a surround view monitor for monitoring the omnidirectional 360 degrees around the vehicle will be described by way of example.

In addition, the retractable and extendable camera mirror device 1 of the present disclosure may serve not only to acquire an image in at least one direction around the vehicle, but also to project an image of a predetermined shape on a vehicle body or a road surface around the vehicle. In this case, the retractable and extendable camera mirror device 1 of the present disclosure may further include an optical system for forming an image of a predetermined shape.

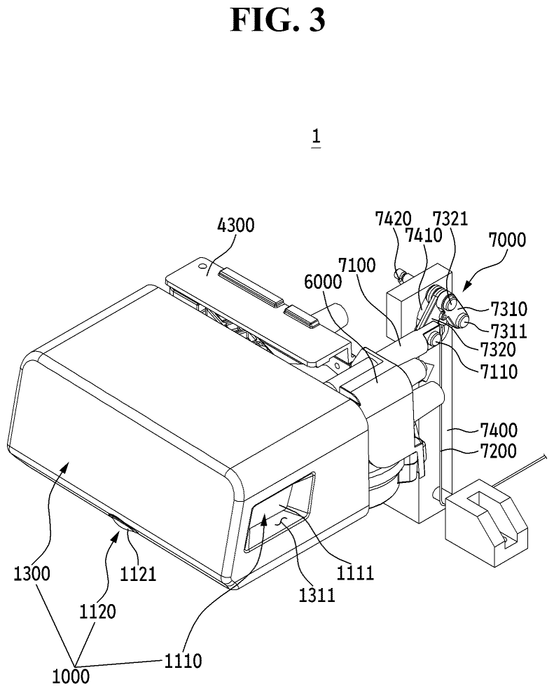

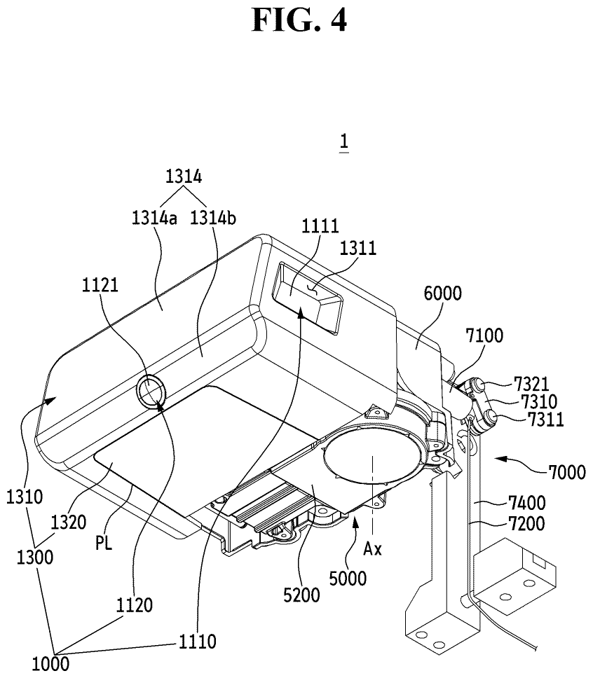

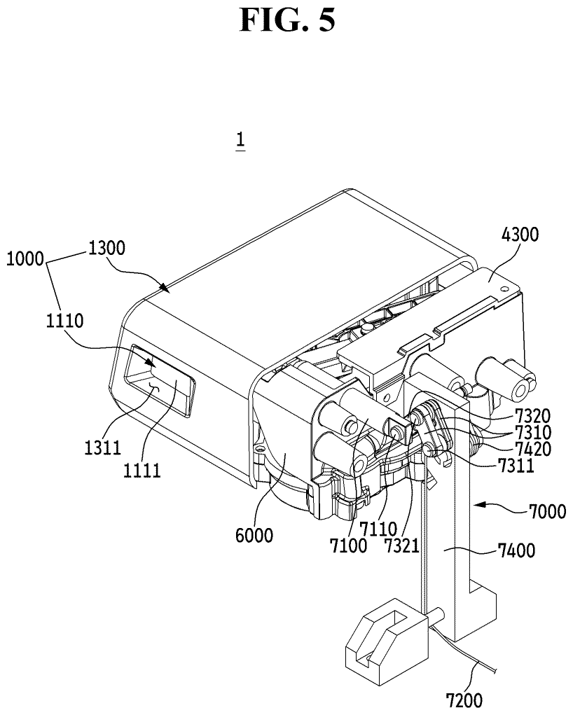

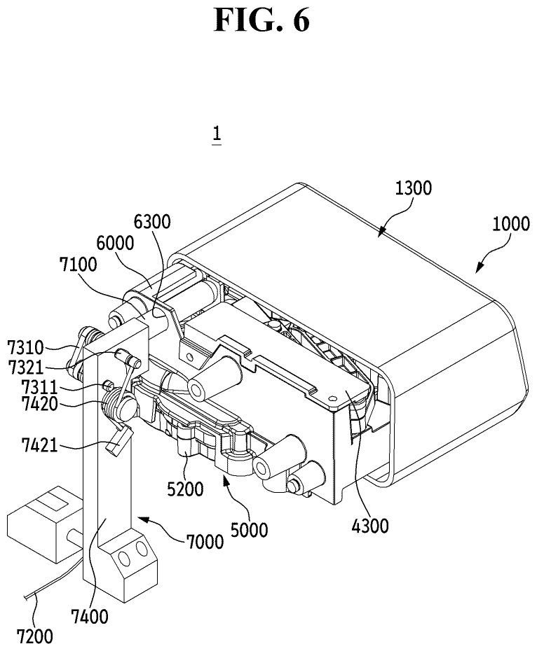

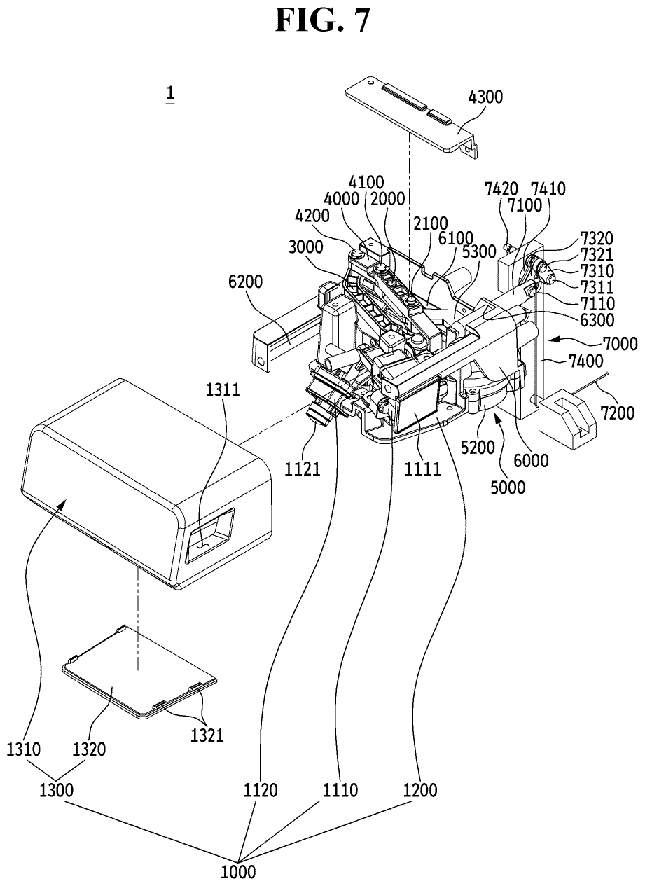

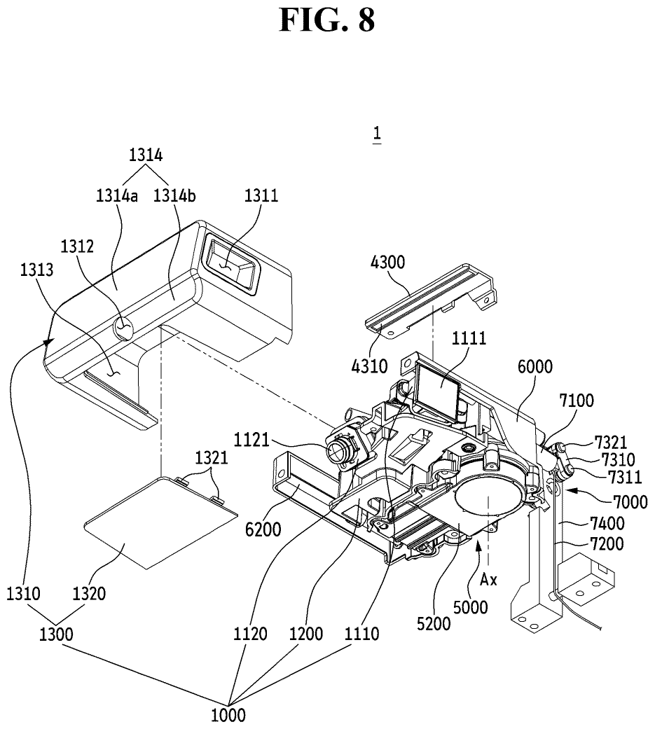

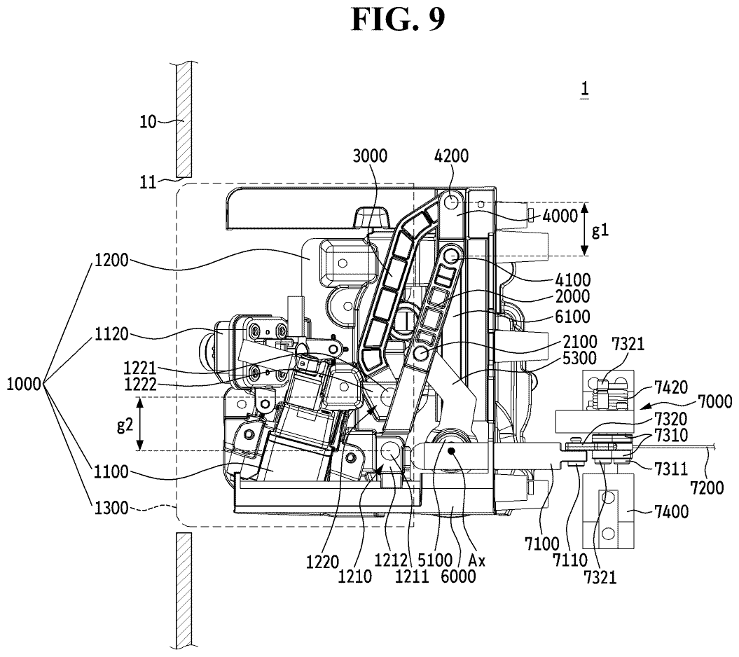

FIGS. 3 to 6 are perspective views illustrating a retractable and extendable camera mirror device in a retracted state according to an embodiment of the present disclosure, FIGS. 7 and 8 are exploded perspective views illustrating a retractable and extendable camera mirror device in a retracted state according to an embodiment of the present disclosure, FIG. 9 is a plan view illustrating a retractable and extendable camera mirror device in a retracted state according to an embodiment of the present disclosure, and a dotted line of FIG. 9 shows a housing unit 1300. For convenience of illustration, FIG. 9 shows an example of a case in which the housing unit 1300 and a guide cover 4300 are depicted in a dotted line.

Referring to FIGS. 3 to 9, the retractable and extendable camera mirror device 1 according to an embodiment of the present disclosure may include the camera assembly 1000, a first link 2000, a second link 3000, a connection link 4000, and a driver (e.g., an actuator) 5000.

The camera assembly 1000 may include at least one camera (e.g., imaging device) 1110 and 1120, a movable portion 1200, and the housing unit 1300.

In an embodiment of the present disclosure, a case in which the at least one camera includes a first camera 1110 and a second camera 1120 will be described by way of example, and a case in which the first camera 1110 acts as a role of an outside side mirror to acquire a side rear image around the vehicle, and the second camera 1120 acts as a role of a surround view monitor function to acquire a side image around the vehicle will be described by way of example.

The movable portion 1200 may be linearly movable into and out of the vehicle body through the opening 11 of the vehicle body panel 10 constituting the body contour of the vehicle under a driving force provided from the driver 5000 to be described later. Hereinafter, the moving direction of the movable portion 1200 will be referred to as a “first direction” in the embodiment of the present disclosure.

The first camera 1110 and the second camera 1120 may be fixed to the movable portion 1200, and accordingly, the first camera 1110 and the second camera 1120 may retract into the interior space defined in the vehicle body or may extend out of the vehicle body so as to be exposed according to the moving direction of the movable portion 1200.

In an embodiment of the present disclosure, an example in which a lens 1111 is disposed to face in a rearward and lateral direction of the vehicle, since the first camera 1110 acquires the side rear image around the vehicle, and a lens 1121 is disposed to be inclined downwardly in a lateral direction of the vehicle, since the second camera 1120 acquires the side image around the vehicle constituting a portion of the surround view is described. However, the present disclosure is not limited thereto, and the installation positions and directions of the first camera 1110 and the second camera 1120 may be variously changed depending on the directions in which the images are to be acquired by the first camera 1110 and the second camera 1120.

The housing unit 1300 may include a camera housing 1310 and a housing cover 1320. The at least one camera 1110 and 1120 and the movable portion 1200 described above may be accommodated in an accommodation space defined via coupling between the camera housing 1310 and the housing cover 1320.

The camera housing 1310 may include a first exposure hole 1311 and a second exposure hole 1312 to enable image acquisition by the first camera 1110 and the second camera 1120, respectively. Each of the first camera 1110 and the second camera 1120 may acquire an image through a corresponding exposure hole among the first exposure hole 1311 and the second exposure hole 1312 in a state in which the camera assembly 1000 has extended out of the vehicle body.

In general, when a surrounding vehicle or a pedestrian looks at the camera assembly 1000 disposed out of the vehicle in a state in which the camera assembly 1000 has extended out of the vehicle body, a viewpoint thereof is typically from the upper side of the camera assembly 1000. When the camera assembly 1000 is viewed from the outside, a joint line (herein interchangeably used with a “parting line”) formed by assembling two or more injection-molded products with each other may be visible, such that an outer appearance design may be deteriorated. Thus, in an embodiment of the present disclosure, the camera housing 1310 may have a single continuous surface to prevent the joint line from being visible when the camera assembly 1000 is viewed from the outside. The housing cover 1320 is coupled to a lower surface of the camera housing 1310 to prevent the parting line PL from being visible when viewed from the outside.

In other words, when the camera assembly 1000 is in the extended state, a surface of the housing unit 1300 visible from the external viewpoint, that is, an upper surface and a side surface of the camera housing 1310 constitute a single, connected surface, as shown in FIG. 2 described above, so that the joint line is not visible. The housing cover 1320 coupled to the lower surface of the camera housing 1310 may be invisible from the external viewpoint, since the parting line PL is formed on the lower surface of the housing unit 1300, thereby preventing deterioration of the outer appearance design due to the parting line and preventing the parting lines from being misaligned each other to cause a step due to manufacturing tolerances or assembly tolerances when two or more injection-molded products are assembled with each other.

In other words, the housing unit 1300 may be formed by coupling two or more injection-molded parts with each other so that a problem such as an undercut does not occur during the injection molding process. When the parting line due to the assembly of the two or more injection-molded products with each other is formed on a surface visible from an external viewpoint, the outer appearance design may be deteriorated. For this reason, the housing cover 1320 may be coupled to the lower surface of the camera housing 1310 to allow the parting line to be formed on the lower surface of the housing unit 1300, thereby preventing the parting line from being visible from the external viewpoint.

In the embodiment of the present disclosure, a case in which at least one hook protrusion 1321 formed on an edge of the housing cover 1320 is disposed to engage with the edge of an open surface 1313 formed as the lower surface of the camera housing 1310 to allow the housing cover 1320 to be coupled to the camera housing 1310 will be described by way of example. However, this is merely an example for helping the understanding of the present disclosure, and the present disclosure is not limited thereto. The housing cover 1320 may be coupled to the camera housing 1310 via various coupling schemes such as hook coupling, screw coupling, fitting coupling, adhesive based coupling, and the like.

One end of the first link 2000 may be pivotably coupled to a first coupling portion 1210 of the movable portion 1200, and one end of the second link 3000 may be pivotably coupled to a second coupling portion 1220 of the movable portion 1200.

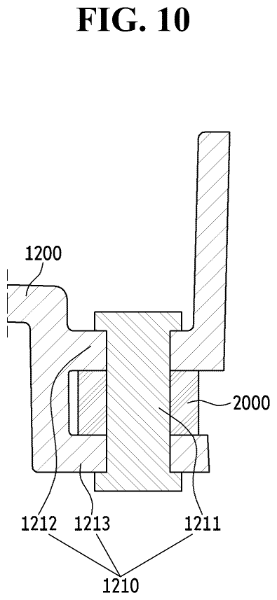

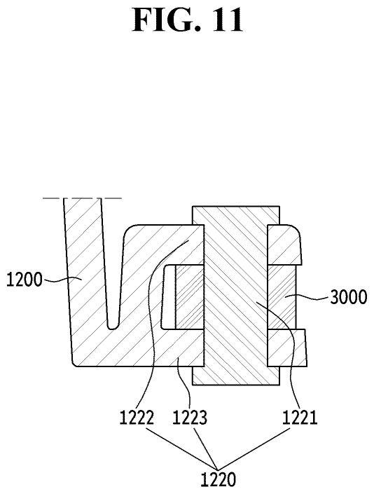

The first coupling portion 1210 may include a plurality of side walls 1212 and 1213 spaced apart from one another at predetermined spacings to allow both opposing ends of a first hinge shaft 1211 to be rotatably inserted into the spacings as shown in FIG. 10. The second coupling portion 1220 may include a plurality of side walls 1222 and 1223 spaced apart from one another at predetermined spacings to allow both opposing ends of a second hinge shaft 1221 to be rotatably inserted into the spacings as shown in FIG. 11.

In this case, the first hinge shaft 1211 and the second hinge shaft 1221 may extend in parallel to the direction of gravity and perpendicular to the ground. In a process in which the movable portion 1200 linearly moves along the first direction parallel to the ground, the first hinge shaft 1211 and the second hinge shaft 1221 may prevent the camera assembly 1000 from sagging due to the weight of the camera assembly 1000.

Since one end of the first link 2000 is disposed between the plurality of side walls 1212 and 1213 of the first coupling portion 1210 arranged along the gravity direction while one end of the second link 2000 is disposed between the plurality of side walls 1222 and 1223 of the second coupling portion 1220 arranged along the gravity direction, the camera assembly 1000 coupled to one end of each of the first link 2000 and the second link 3000 may be prevented from sagging in the gravity direction due to the load thereof, and unnecessary movement such as shaking of the camera assembly 1000 may be prevented.

The other end of the first link 2000 and the other end of the second link 3000 may be pivotably connected to both opposing ends of the connection link 4000, respectively, and may pivot about axes parallel to each other, respectively. The other end of the first link 2000 may be pivotably connected to one end of the connection link 4000 via a first connection shaft 4100, and the other end of the second link 3000 may be pivotably connected to the other end of the connection link 4000 via a second connection shaft 4200.

In this case, the first hinge shaft 1211, the second hinge shaft 1221, the first connection shaft 4100, and the second connection shaft 4200 may become perpendicular to the ground and may extend in a parallel manner to one another for the movement of the movable portion 1200.

The above-described connection link 4000 may be linearly movable along a guide groove 6100 formed in a base 6000 along a second direction. When the connection link 4000 moves, the movable portion 1200 connected to the connection link 4000 via the first link 2000 and the second link 3000 may be linearly moved along the first direction.

The driver 5000 may provide a driving force (e.g., an actuation force) for the movement of the camera assembly 1000. The driver 5000 may include a driving shaft 5100 configured to rotate about a driving axis Ax, and the driving shaft 5100 may be rotated about the driving axis Ax by the driving force generated from a driving system including a motor and a gear accommodated in a driver housing 5200.

In this case, the driver 5000 may be coupled to the base 6000, and the base 6000 may be coupled to one side defining the interior space of the vehicle body so that the position of the driver 5000 may be fixed.

The driving force provided from the driver 5000 may be transmitted to the first link 2000 via a driving link 5300 connected to and disposed between the driving shaft 5100 and the first link 2000. As one end of the driving link 5300 connected to the driving shaft 5100 pivots about the driving axis Ax, a position of the other end of the driving link 5300 may be changed to allow the movable portion 1200 to be linearly moved along the first direction.

In other words, the other end of the driving link 5300 may be connected to a center of the first link 2000 so as to pivot about a central shaft 2100. When one end of the driving link 5300 pivots about the driving axis Ax under the force from the driving shaft 5100, the connection link 4000 may be linearly moved in the second direction along the guide groove 6100 formed in the base 6000, and simultaneously, one end of the first link 2000 and one end of the second link 3000 may pivot about the first hinge shaft 1211 and the second hinge shaft 1221, respectively. In turn, as the other end of the first link 2000 and the other end of the second link 3000 pivot around the first connection shaft 4100 and the second connection shaft 4200, respectively, the movable portion 1200 may be linearly moved along the first direction.

In an embodiment of the present disclosure, the other end of the driving link 5300 is connected to the first link 2000 in order to prevent structural interference from occurring, since the first link 2000 is disposed closer to the driving axis Ax than the second link 3000. However, the present disclosure is not limited thereto, and the other end of the driving link 5300 may be connected to the second link 3000 instead, if the second link 3000 is disposed closer to the driving axis Ax than the first link 2000.

Herein, a spacing between the first hinge shaft 1211 and a second hinge shaft 1221 is referred to as a first spacing g1 and a spacing between the first connection shaft 4100 and the second connection shaft 4200 is referred to as a second distance g2. The first spacing g1 and the second spacing g2 may be equal to each other. This is because the movable portion 1200 may be linearly translated along the first direction when the connection link 4000 is linearly translated in the second direction along the guide groove 6100 under the condition that the first spacing g1 and the second spacing g2 are equal.

In other words, when the first spacing g1 and the second spacing g2 are equal to each other, the movable portion 1200 and the connection link 4000 may be linearly movable along the first direction and the second direction that are orthogonal to each other. Thus, the moving direction of the camera assembly 1000 may be more easily controlled. However, when the first spacing g1 and the second spacing g2 are different, the first direction and the second direction may not be orthogonal to each other, thereby making it relatively difficult to control the moving direction of the camera assembly 1000.

In addition, when the connection link 4000 linearly moves along the second direction, this means that the first connection shaft 4100 and the second connection shaft 4200 are arranged linearly along the second direction, and similarly, this means that the first hinge shaft 1211 and the second hinge shaft 1221 are also arranged linearly along the second direction.

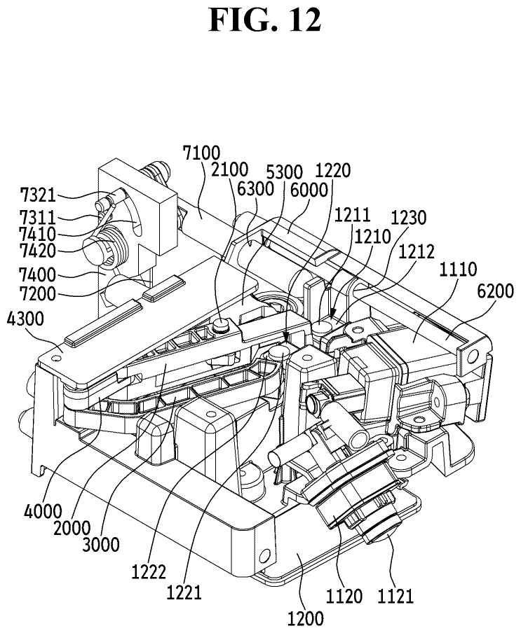

In one example, the movable portion 1200 may include at least one through hole 1230. Accordingly, the guide rail 6200 formed on the base 6000 along the moving direction of the movable portion 1200 may pass through the through hole 1230. As a result, when the movable portion 1200 moves in the first direction as shown in FIG. 12, the at least one through hole 1230 may be guided along the at least one guide rail 6200 to support the load of the camera assembly 1000, thereby further preventing sagging due to the load of the camera assembly 1000 and preventing unnecessary movement from occurring.

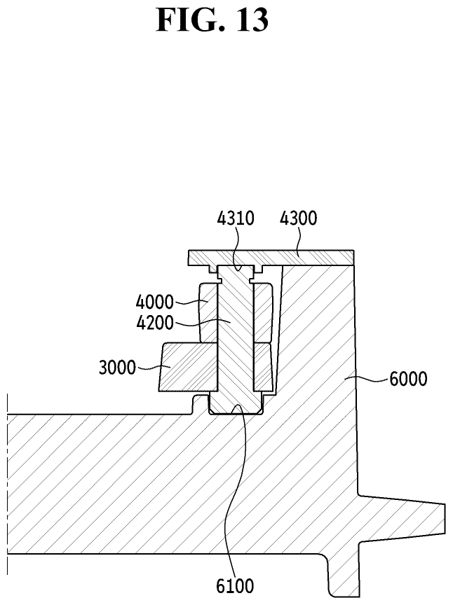

In addition, one end of each of the first connection shaft 4100 and the second connection shaft 4200 may be inserted into a guide groove 6100 of the base 6000, and thus may be guided to linearly move along the guide groove 6100 when the driving link 5300 pivots. As shown in FIG. 13, a guide cover 4300 including a receiving groove 4310 may be coupled to the base 6000 to allow the other end of each of the first connection shaft 4100 and the second connection shaft 4200 to be movably inserted, so that unnecessary movement of the first connection shaft 4100 and the second connection shaft 4200 may be prevented when the connection link 4000 moves. Thus, sagging of the camera assembly 1000 or unnecessary movement thereof may be prevented, and thus, a situation in which the camera assembly 1000 may collide with the vehicle body panel 10 and thus be damaged while the camera assembly 1000 moves through the opening 11 of the vehicle body panel 10 may be prevented.

In this regard, FIG. 13 illustrates one example of the second connection shaft 4200 to which the other end of the second link 3000 is connected. However, the present disclosure is not limited thereto. Like the second connection shaft 4200, the movement of both opposing ends of the first connection shaft 4100 may be guided by the guide groove 6100 of the base 6000 and the receiving groove 4310 of the guide cover 4300, respectively, so that the unnecessary movement does not occur.

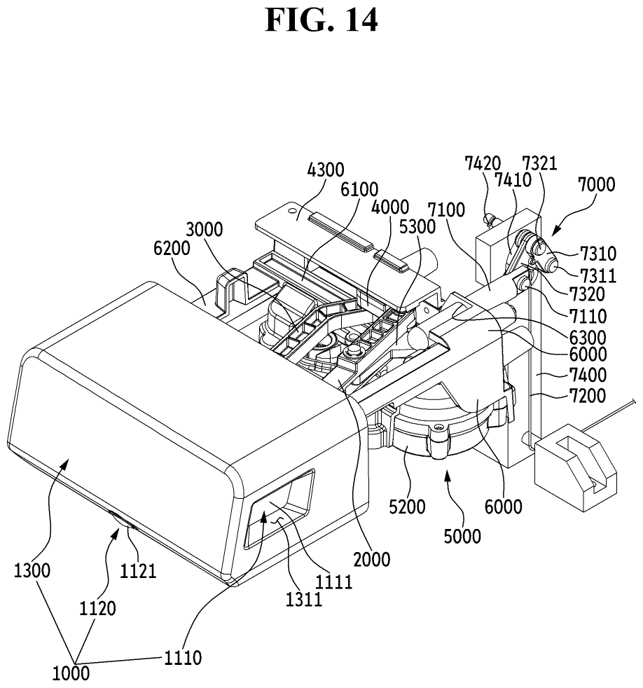

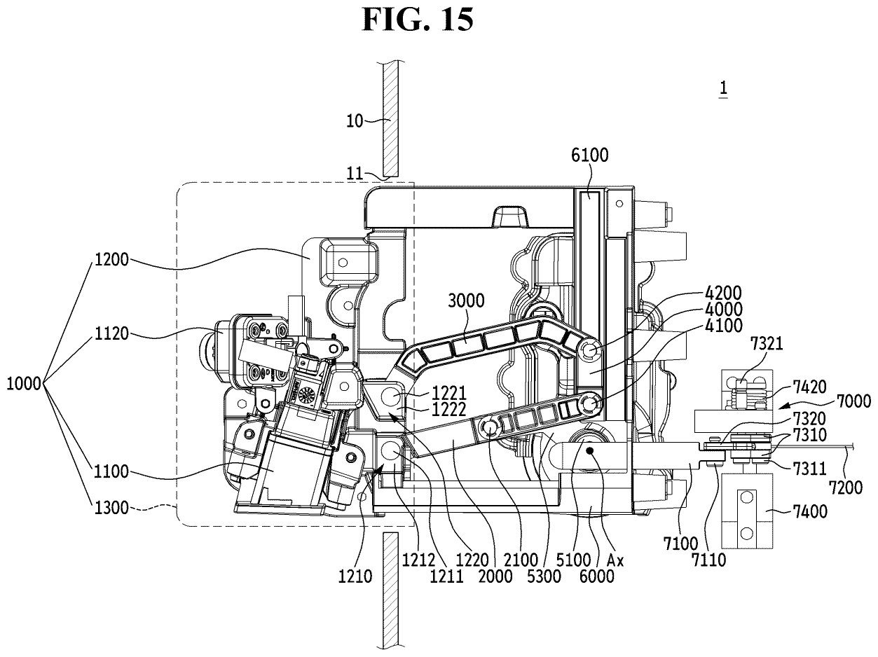

In the retractable and extendable camera mirror device 1 of the present disclosure described above, as the driving shaft 5100 of the driver 5000 rotates in any one direction (e.g., counterclockwise direction when viewed from above) of the two directions around the driving axis Ax such that the movable portion 1200 moves along the first direction, at least a portion of the camera assembly 1000 may extend out of the vehicle body, as shown in FIGS. 14 and 15, so that the side-rear image and the side image around the vehicle may be acquired. When the driving shaft 5100 of the driver 500 rotates in the other direction (e.g., clockwise direction) of the two directions around the driving axis Ax, the camera assembly 1000 may retract into the interior space provided in the vehicle body.

FIG. 15 show an example of a case in which the housing unit 1300 and the guide cover 4300 are depicted as a dotted line for convenience of illustration.

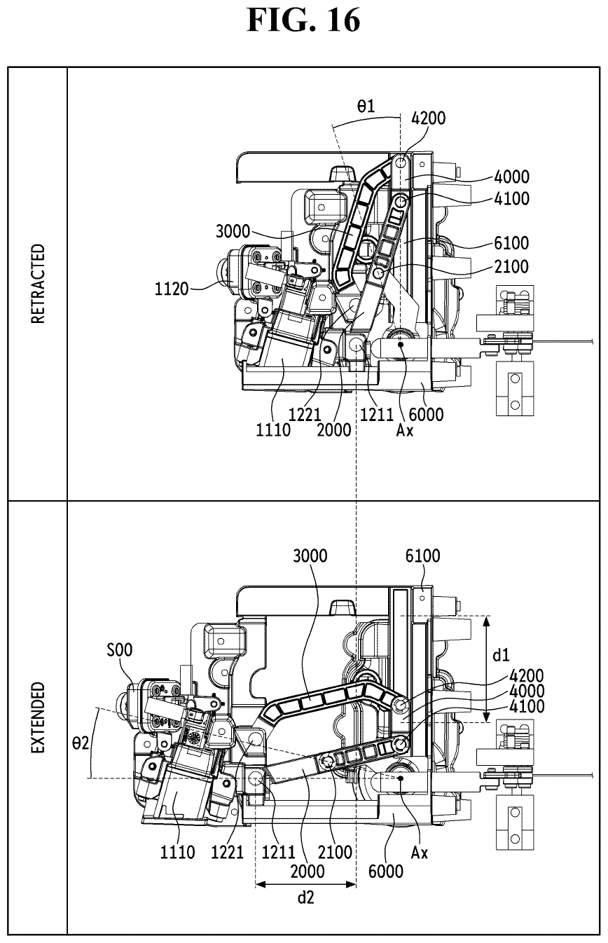

In one example, as shown in FIG. 16, a first angle θ1 between the central shaft 2100 of the first link 2000 and the first connection shaft 4100 around the driving shaft Ax in the state in which the camera assembly 1000 is in the retracted state and a second angle θ2 between the central shaft 2100 of the first link 2000 and the first hinge shaft 1211 around the driving shaft Ax in a state in which the camera assembly 1000 is in the extended state may be different. This may allow at least some of the components to be used without modification even if an extension distance (retraction distance) of the camera assembly 1000 is changed.

In general, when the extension distance (e.g., extension stroke) of the camera assembly 1000 is fixed, the first angle θ1 and the second angle θ2 corresponding to the extension distance are designed to have an equal angle. However, when the extension distance of the camera assembly 1000 is changed due to a design change or like, the first angle θ1 and the second angle θ2 may also be changed. Thus, it may be necessary to re-design the retractable and extendable camera mirror device 1 of the present disclosure based on the changed extension distance, which may increase the cost. For this reason, in an embodiment of the present disclosure, the first angle θ1 and the second angle θ2 may be configured to be different from each other. Thus, even when the extension distance of the camera assembly 1000 is changed, some components including the first link 2000 and the second link 3000 may be used without modification.

In this case, the fact that the first angle θ1 and the second angle θ2 are different from each other may mean that a moving distance d1 of the connection link 4000 and an extension distance d2 of the camera assembly 1000 are different from each other.

For example, when the second angle θ2 is smaller than the first angle θ1, this may mean that the extension distance d2 of the camera assembly 1000 is greater than the movement distance d1 of the connection link 4000 when the camera assembly 1000 extends out of the vehicle body. In this case, even when the extended distance of the camera assembly 1000 is changed to be relatively small, the first link 2000, the second link 3000, and the connection link 4000 may be used without modification.

In an embodiment of the present disclosure, the second angle θ2 being greater than the first angle θ1 is merely an example for helping understanding of the present disclosure, and the present disclosure is not limited thereto. One of the first angle θ1 or the second angle θ2 may be greater than the other thereof such that even when the extension distance of the camera assembly 1000 is changed, some components including the first link 2000, the second link 3000, and the connection link 4000 may be used without modification.

In one example, the retractable and extendable camera mirror device 1 according to the present disclosure may further include a manual manipulator 7000, which allows a human operator to directly and manually move the camera assembly 1000 even when it is difficult to move the camera assembly 1000 using the driving force of the driver 5000 due to a failure of various components including the driver 5000 or ice formation occurring in the opening 11 of the vehicle panel 10, thereby enabling the vehicle to be driven even in these situations.

The manual manipulator 7000 may include a push shaft 7100, a cable 7200 to which an external force for movement of the push shaft 7100 is input, and at least one transmission link 7310 and 7320 to transmit the external force input to the cable 7200 to the push shaft 7100.

The push shaft 7100 may be disposed so that its end directly or indirectly contacts a portion allowing movement of the camera assembly 1000, and may serve to move under the external force input transmitted via the cable 7200 to allow the camera assembly 1000 to move.

In an embodiment of the present disclosure, a case in which the push shaft 7100 may be inserted into and disposed in a through hole 6300 formed in the base 6000 so as to move therethrough along the first direction. A case in which an end of the push shaft 7100 is disposed to be in contact with one side of the movable portion 1200 so that a pushing force may be applied to the movable portion 1200 when the external force is input to the cable 7200 will be described by way of example. However, this is merely an example for helping understanding of the present disclosure. In this case, under the external force input to the cable 7200, the camera assembly 1000 may move along the first direction so that a portion of the camera assembly 1000 may extend out of the vehicle body and be exposed. When the camera assembly 1000 is in the retracted state, the end of the push shaft 7100 may be disposed to be in contact with one side of the movable portion 1200 and may be prepared to apply the pushing force to one side of the movable portion 1200. However, this is merely an example, and the present disclosure is not limited thereto. An end of the push shaft 7100 may be disposed to abut a portion to which the force to move the camera assembly 1000 is directly or indirectly applied, such as one side of the camera assembly 1000, one side of the first link 2000, one side of the second link 3000, and the like.

The at least one transmission link may include a first transmission link 7310 having one end pivotably mounted on a mounting bracket 7400 about a first shaft 7311, and a second transmission link 7320 having one end pivotably connected to the other end of the first transmission link 7310 about a second shaft 7321. The other end of the second transmission link 7320 may be pivotably connected to the push shaft 7100 via a third shaft 7110.

In this regard, at least one of the first transmission link 7310 or the second transmission link 7320 may be connected, at one side thereof, to the cable 7200. When a pulling force is applied to the cable 7200, the second shaft 7321 may move from one end to the other end of a guide hole 7410 formed to have a predetermined radius around the first shaft 7311 while an angle between the first transmission link 7310 and the second transmission link 7320 around the second shaft 7321 is changed, such that a pushing force is applied and the push shaft 7100 moves in the first direction. Thus, the movable portion 1200 may move along the first direction, and thus a portion of the camera assembly 1000 may extend out of the vehicle body and be exposed. The operator may pull the camera assembly 1000 out manually from that position.

In this regard, the manual manipulator 7000 may further include an elastic member 7420 that allows the other end of the first transmission link 7310, that is, the second shaft 7321 to move in a direction from the other end of the guide hole 7410 toward one end thereof and thus returns to an original position when the external force applied to the cable 7200 is removed.

One end of the elastic member 7420 may be fixed by a fixing protrusion 7421 and the other end of the elastic member 7420 may be disposed to apply a force to the second shaft 7321 to bias the second shaft 7321 toward one end of the guide hole 7410. When an external force is input to pull the cable 7200, the elastic member 7420 may be compressed and thus the second shaft 7321 may move in a direction from one end of the guide hole 7410 toward the other end thereof. When the external force input to the cable 7200 is removed, the second shaft 7321 may move, by a restoring force of the elastic member 7420, in a direction from the other end of the guide hole 10 toward one end thereof and may return to its base position.

In other words, the guide hole 7410 may be disposed closer to the camera assembly 1000 in the first direction than the first shaft 7311, and a vertical level of one end of the guide hole may be higher than that of the other end thereof. When the external force pulling the first transmission link 7310 and/or the second transmission link 7320 downward in a direction perpendicular to the ground is input to the cable 7200, the elastic member 7720 may be compressed such that the second shaft 7321 moves from one end of the guide hole 7410 toward the other end thereof, and thus an angle between the first transmission link 7310 and the second transmission link 7320, that is, an angle between the first shaft 7311 and the third shaft 7110 around the second shaft 7321 increases. Thus, the push shaft 7100 may move toward the camera assembly 1000 along the first direction, such that a pushing force is applied to the camera assembly 1000. Herein, an embodiment where the guide hole 7410 is arranged vertically is described by way of example. However, the present disclosure is not limited thereto, and the guide hole 7410 may be arranged horizontally such that the pulling force of the cable 7200 is exerted substantially sideways and the first transmission link 7310 and the second transmission link 7320 move within a substantially horizontal plane.

In addition, when the external force input to the cable 7200 is removed, the second shaft 7321 may move in a direction from the other end of the guide hole 7410 toward one end thereof by the restoring force of the elastic member 7420, and thus the push shaft 7100 may move in a direction away from the camera assembly 1000 while the angle between the first shaft 7311 and the third shaft 7110 around the second shaft 7321 decreases.

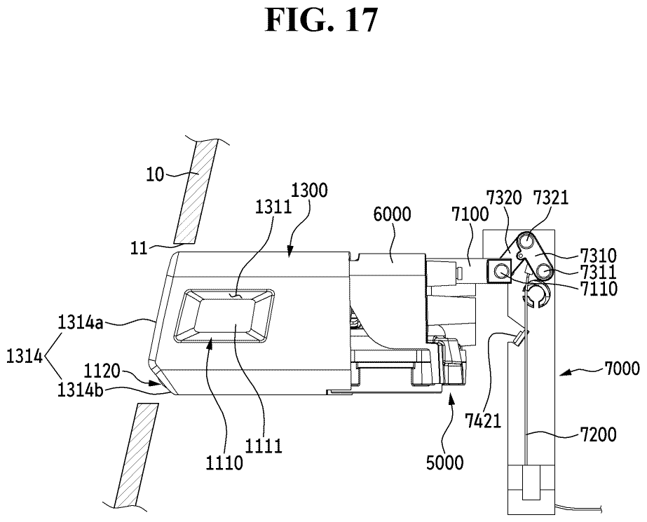

The manual manipulator 7000 as described above may be configured so that no force of pushing the camera assembly 1000 is applied due to the push shaft 7100 as shown in FIG. 17 in a normal state. However, when an operator needs to manually move the camera assembly 1000 due to a failure of the driver 5000 or ice formation, the operator may actuate a device configured to pull the cable 7200 in the vehicle so that a force of pulling the cable 7200 is applied to the cable 7200.

In this regard, the human operator may directly pull the end of the cable 7200 disposed inside the vehicle, or may activate a separate actuator connected to the end of the cable 7200 to indirectly apply the pulling force to the cable 7200.

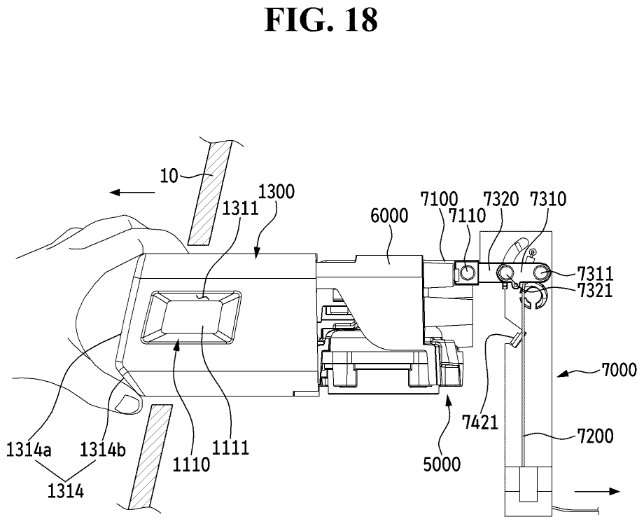

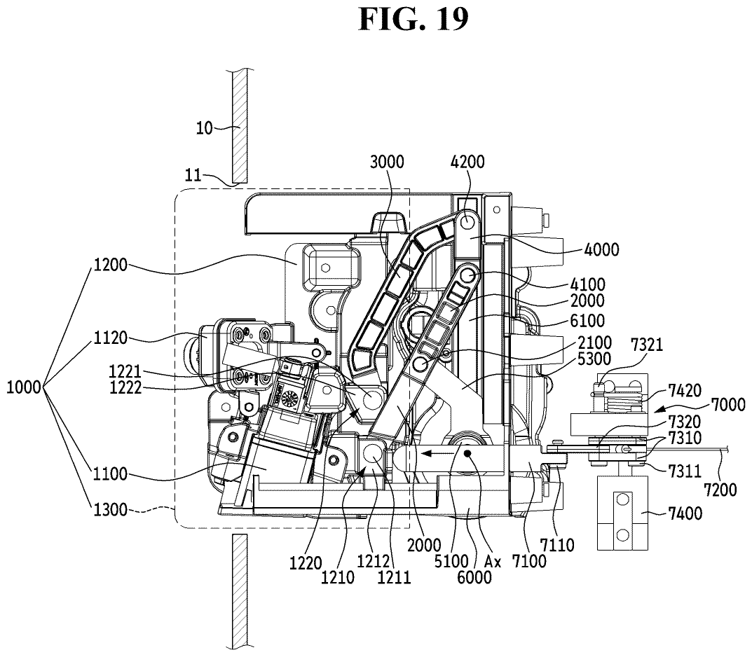

When the pulling force is applied to the cable 7200, the second shaft 7321 may move in a direction from one end to the other end of the guide hole 7410, as shown in FIGS. 18 and 19, such that an angle between the first transmission link 7310 and the second transmission link 7320 around the second shaft 7321 increases so that the first transmission link 7310 and the second transmission link 7320 are arranged substantially linearly. Thus, the push shaft 7100 may move in a direction toward the camera assembly 1000, and thus a pushing force may be applied to the camera assembly 1000. Accordingly, a portion of the camera assembly 1000 may be exposed out of the vehicle body through the opening 11 formed in the vehicle panel 10, thereby allowing the operator to grasp and pull the camera assembly 1000 manually so that the camera assembly 1000 may be extended to a position at which an image in at least one direction around the vehicle may be acquired.

In one example, in the retracted state of the camera assembly 1000, an outer surface 1314 of the housing unit 1300 facing outwardly of the vehicle body may include a body surface 1314a constituting the body line of the vehicle corresponding to the vehicle body panel 10, and an inclined surface 1313b for installing the second camera 1120. The inclined surface 1314b may be formed to extend inclinedly toward the inside of the vehicle body from a lower end of the body surface 1314a.

For example, when a surface for installing the second camera 1120 is disposed at the upper end of the body surface 1314a, it may be necessary for the surface to protrude outwardly beyond the vehicle body panel 10 in order to secure the necessary viewing angle of the second camera 1120. However, in an embodiment of the present disclosure, since the inclined surface 1314b for installing the second camera 1120 is formed to extend in an inclined manner toward the inside of the vehicle body from the lower end of the body surface 1314a, the angle of view of the second camera 1120 may be secured through a space between the lower end of the body surface 1314a and the opening 1 of the vehicle body panel 10. Accordingly, the surface for installation of the second camera 1120 may be prevented from protruding outwardly beyond the vehicle body.

In an embodiment of the present disclosure, a case in which the lens 1121 of the second camera 1120 is disposed to protrude outwardly beyond the inclined surface 1314b in order to secure the angle of view of the second camera 1120 is described by way of example. However, the present disclosure is not limited thereto, and the installation position of the second camera 1120 may vary depending on the angle of view required by the second camera 1120.

In this regard, the inclined surface 1314b may be formed to extend in the inclined manner from the lower end of the body surface 1314a toward the inside of the vehicle body, such that there is a spacing between the opening 11 of the vehicle body panel 10 and the lower end of the inclined surface 1314b. Thus, when the camera assembly 1000 retracts into the interior space of the vehicle body, the interior space of the vehicle body may be visible from an external viewpoint, or foreign substances may be introduced from outside into the interior space through the spacing between the opening 11 of the vehicle body panel 10 and the lower end of the inclined surface 1314b. For this reason, this spacing may be required to be shielded.

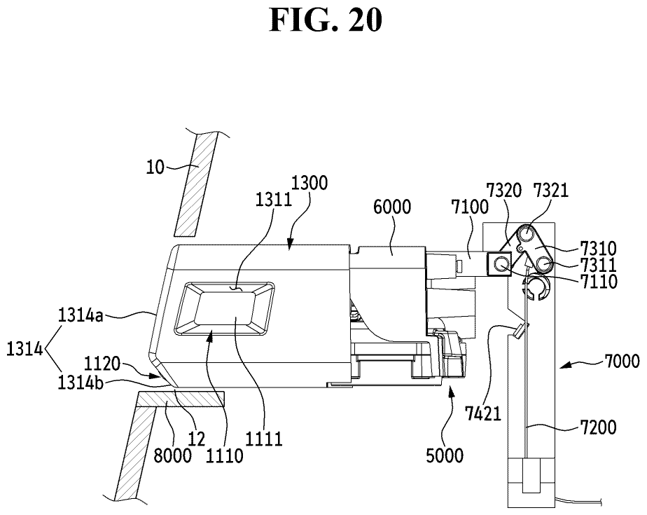

FIG. 20 is a schematic diagram showing a shield according to an embodiment of the present disclosure.

Referring to FIG. 20, a shield 8000 according to the embodiment of the present disclosure may be embodied as a plate having an area greater than a spacing 12 so that the spacing 12 between the opening 11 of the vehicle body panel 10 and the lower end of the inclined surface 1313b may be shielded therewith when viewed from the outside.

In this regard, in FIG. 20, a case in which the shield 8000 is formed as a separate member and is coupled to an edge defining the opening 11 of the vehicle body panel 10 is described by way of example. However, the present disclosure is not limited thereto, and a portion defining the opening 11 of the vehicle body panel 10 may be formed to extend in a manner corresponding to the shield 8000, and the extended portion thereof may be bent to seal or shield the spacing 12.

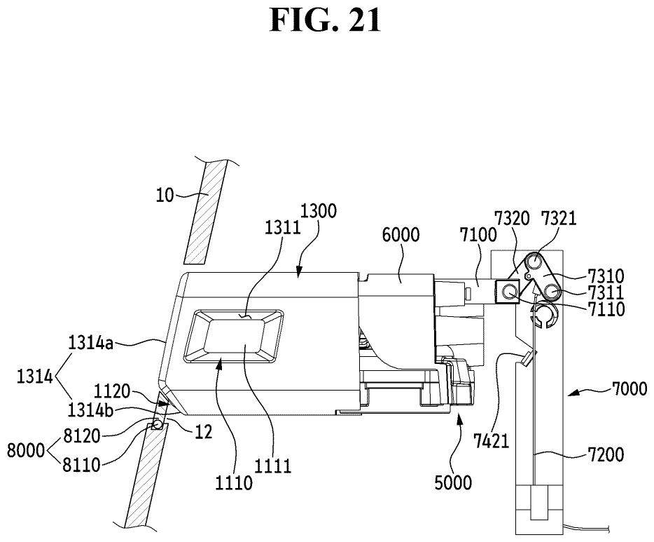

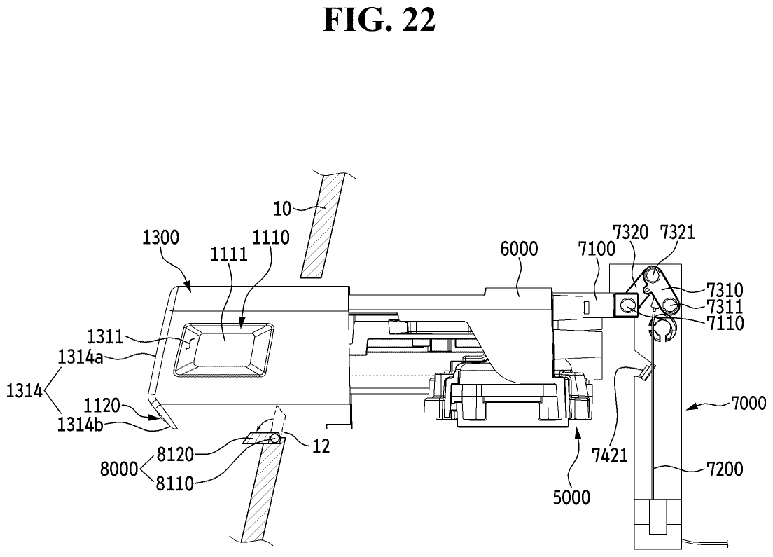

FIGS. 21 and 22 are schematic diagrams showing a shield according to another embodiment of the present disclosure.

Referring to FIGS. 21 and 22, the shield 8000 according to another embodiment of the present disclosure may include a pivotable member 8120 constructed to be pivotable about a pivot shaft 8110. The pivotable member 8120 may be displaced to screen a portion of the opening 11 of the vehicle body panel 10 under the operation of an elastic member such as a torsion spring.

In other words, a lower portion of the opening 11 of the vehicle body panel 10, that is, the space 12 between the lower end of the body surface 1314a and the opening 11 of the vehicle body panel 10 may be shielded with the pivotable member 8120 of the shield 8000 according to another embodiment of the present disclosure, as shown in FIG. 21, when the camera assembly 1000 is in the retracted state. When the camera assembly 1000 is brought into the extended state by the operation of the driver 5000 or by the manual manipulator 7000, the pivotable member 8120 may be subjected to the force transmitted from the camera assembly 1000, and thus, may pivot out around the pivot shaft 810, such that the camera assembly 1000 may extend from the vehicle body. When the camera assembly 1000 retracts into the vehicle body again, the pivotable member 8120 may pivot in so that the lower portion of the opening 11 of the vehicle body panel 10 is shielded therewith, by the restoring force of the elastic member, to prevent the interior space of the vehicle body from being visible to the viewer out of the vehicle body.

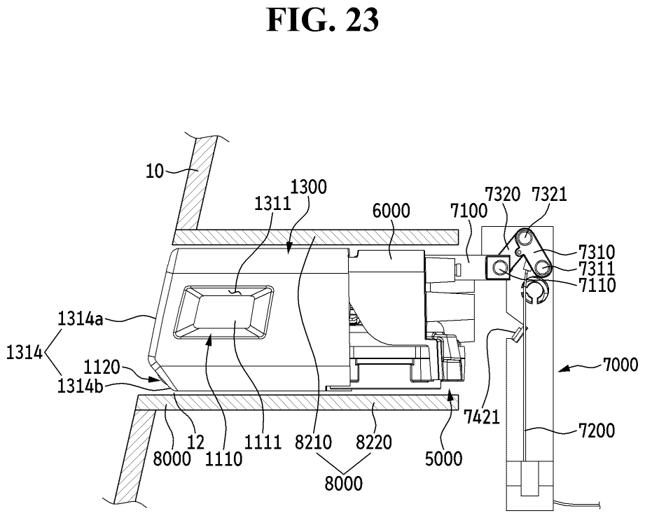

FIG. 23 is a schematic diagram showing a shield according to still another embodiment of the present disclosure.

Referring to FIG. 23, the shield 8000 according to still another embodiment of the present disclosure may be configured to include an outer cover 8210 and 8220 accommodating the retractable and extendable camera mirror device 1 of the present disclosure therein. The opening 11 of the vehicle body panel 10 may be shielded with the outer cover 8210 and 8200. Thus, the spacing 12 between the opening 11 of the vehicle body panel 10 and the lower end of the inclined surface 1314b may be shielded therewith when the camera assembly 1000 is in the retreated state in a similar manner to the shield 8000 described above.

As described above, in the retractable and extendable camera mirror device 1 of the present disclosure, the camera assembly 1000 may linearly move out of and into the interior space of the vehicle body along the first direction so as to extend from and retract into the vehicle body. Thus, a space required for the movement of the camera assembly 1000 may be reduced compared to a case in which the camera assembly 1000 moves out of and into the interior of the vehicle body while the camera assembly 1000 pivots or swings. Even when the automatic actuation of the camera assembly 1000 is not available due to freezing in the cold weather or the failure of the driver 5000, the human operator may manually extend the camera assembly 1000, thereby enabling the vehicle to be driven even in these situations.

In concluding the detailed description, those skilled in the art will appreciate that many variations and modifications can be made to the exemplary embodiments without substantially departing from the principles of the present disclosure. Therefore, the disclosed exemplary embodiments are used in a generic and descriptive sense only and not for purposes of limitation.

What is claimed is:

1. A camera mirror device comprising:
a camera assembly that is movable in a first direction into and out of a vehicle body through an opening provided in a vehicle body panel;
a first link having a first end pivotably connected to a first coupling portion of the camera assembly to allow the first link to pivot about a first hinge shaft;
a second link having a first end pivotably connected to a second coupling portion of the camera assembly to allow the second link to pivot about a second hinge shaft;
a connection link having both ends thereof pivotably connected to a second end of the first link and a second end of the second link via a first connection shaft and a second connection shaft, respectively, wherein the connection link is configured to be movable along a second direction, which intersects the first direction; and
a driver that transmits a driving force to the first link via a driving link that pivots about a driving shaft for a movement of the camera assembly,
wherein the camera assembly includes a housing unit including a camera housing and a housing cover coupled to each other to form a camera receiving space for accommodating at least one camera therein, and
wherein a spacing between the first hinge shaft and the second hinge shaft is equal to a spacing between the first connection shaft and the second connection shaft.

2. The camera mirror device of claim 1, wherein the housing cover is coupled to a lower surface of the camera housing.

3. The camera mirror device of claim 1, wherein an outer surface of the housing unit that faces outward from the vehicle body includes:
a body surface, wherein when the camera assembly is in a retracted state into the vehicle body, the body surface and the vehicle body panel are disposed flush with each other to constitute a coplanar body line of the vehicle; and
a inclined surface that extends from a lower end of the body surface in an inclined manner toward an inside of the vehicle body.

4. The camera mirror device of claim 3, wherein a lens of the at least one camera protrudes outward beyond the inclined surface through an exposure hole formed in the inclined surface.

5. The camera mirror device of claim 3, further comprising a shield configured to shield a spacing between the opening of the vehicle body panel and a lower end of the inclined surface when the camera assembly is retracted into the vehicle body.

6. The camera mirror device of claim 5, wherein the shield includes an outer cover configured to surround at least a portion of the camera assembly so that the spacing between the opening of the vehicle body panel and the lower end of the inclined surface is shielded with the outer cover when the camera assembly is retracted into the vehicle body.

7. The camera mirror device of claim 1, wherein the first coupling portion includes a plurality of first side walls, to allow the first hinge shaft to pass through the first end of the first link, and each of both ends of the first hinge shaft to be inserted into each of the plurality of first side walls, and
wherein the second coupling portion includes a plurality of second side walls, to allow the second hinge shaft to pass through the first end of the second link, and each of both ends of the second hinge shaft to be inserted into each of the plurality of second side walls.

8. The camera mirror device of claim 7, wherein the first connection shaft and the second connection shaft are arranged along the second direction, and
wherein a first end of each of the first connection shaft and the second connection shaft is movably inserted into a guide groove, which is formed in a base and extends along the second direction, to allow the connection link to be movable along the second direction.

9. The camera mirror device of claim 8, further comprising:
a guide cover including a receiving groove that extends along an arrangement direction of the first connection shaft and the second connection shaft, wherein the receiving groove faces the guide groove,
wherein a second end of each of the first connection shaft and the second connection shaft is movably inserted into the receiving groove to allow the second end of each of the first connection shaft and the second connection shaft to move along the receiving groove as the first end of each of the first connection shaft and the second connection shaft moves along the guide groove.

10. The camera mirror device of claim 9, wherein the guide cover is integrally formed with the base.

11. The camera mirror device of claim 8, wherein the base includes at least one guide rail formed thereon to extend along a moving direction of the camera assembly.

12. The camera mirror device of claim 7, wherein a first end of the driving link is connected to the driving shaft that rotates about a driving axis, and a second end thereof is pivotably connected to a center of the first link via a central shaft, and
wherein an angle between the central shaft and the first connection shaft with respect to the driving axis when the camera assembly is in a retracted state into the vehicle body is different from an angle between the first hinge shaft and the central shaft with respect to the driving axis when the camera assembly is in an extended state from the vehicle body.

13. The camera mirror device of claim 7, wherein an extension distance by which the camera assembly extends from the vehicle body is different from a displacement distance of the connection link.

14. The camera mirror device of claim 1, further comprising:
a manual manipulator that causes a portion of the camera assembly to extend out of the vehicle body through the opening to allow an operator to manually extend the camera assembly out of the vehicle body,
wherein the manual manipulator includes:
a push shaft that is movable along the first direction;
a cable to which an external force for moving the camera assembly is input; and
at least one transmission link that transmits the external force input to the cable to the push shaft to cause the push shaft to move along the first direction.

15. The camera mirror device of claim 14, wherein an end of the push shaft is in contact with one of the camera assembly, the first link, the second link, or the connection link to allow a portion of the camera assembly to extend out of the vehicle body through the opening by the external force input to the cable.

16. The camera mirror device of claim 14, wherein the at least one transmission link includes:
a first transmission link having a first end mounted on a mounting bracket to pivot about a first shaft; and
a second transmission link having a first end pivotably connected to a second end of the first transmission link via a second shaft, and
wherein a second end of the second transmission link is pivotably connected to the push shaft via a third shaft.

17. The camera mirror device of claim 16, wherein the cable is connected to at least one of the first transmission link or the second transmission link, and
wherein, in response to an external force that pulls the cable being input thereto, the second shaft moves along a guide hole formed in the mounting bracket and having a constant radius around a center of the first shaft.

18. The camera mirror device of claim 17, wherein, in response to the external force of pulling the cable being input thereto, the second shaft moves in a direction from a first end toward a second end of the guide hole to allow an angle between the first shaft and the third shaft with respect to the second shaft to increase.

19. The camera mirror device of claim 18, wherein the manual manipulator further includes an elastic member that biases the second shaft toward the first end from the second end along the guide hole.

20. The camera mirror device of claim 19, wherein, in response to the external force of pulling the cable being input thereto, the elastic member is compressed and the second shaft is moved toward the second end of the guide hole to allow the push shaft to move along the first direction, and the angle between the first shaft and the third shaft with respect to the second shaft increases, and
wherein, in response to the external force of pulling the cable being removed therefrom, the second shaft moves toward the first end of the guide hole by a restoring force of the elastic member to allow the push shaft to return to a base position, and thus the angle between the first shaft and the third shaft with respect to the second shaft decreases.
